(19) United States
(12) Patent Application Publication
(10) Pub. No.: US 2017/0286301 A1
(43) Pub. Date: Oct. 5, 2017

(54) METHOD, SYSTEM, AND APPARATUS FOR A COHERENCY TASK LIST TO MINIMIZE CACHE SNOOPING BETWEEN CPU AND FPGA

(71) Applicant: Intel Corporation, Santa Clara, CA (US)

(72) Inventors: Stephen S. Chang, Hillsboro, OR (US); Pratik M. Marolia, Hillsboro, OR (US)

(21) Appl. No.: 15/089,467

(22) Filed: Apr. 1, 2016

(51) Int. Cl. G06F 12/08

(52) U.S. Cl. CPC G06F 12/0831; G06F 12/084; G06F 2212/314; G06F 2212/621

(57) ABSTRACT

Method and system implementing a task list in a cache agent for reducing cache line snoops. One embodiment comprises: monitoring a list of tasks that is stored in a shared cache memory and shared by a plurality of cache agents, wherein each task in the list of tasks is associated with at least a data block, a task command, and a task state, and wherein the list of tasks is fully coherent amongst the plurality of cache agents and the data block associated with each task is not coherent amongst the plurality of cache agents; detecting an access to the list of tasks and responsive to the detecting, snoop the list of tasks to generate a response, wherein the response comprises performing the task command of the accessed task on the associated data block to generate a result and storing the result in the same or different data block.

### BACKGROUND INFORMATION

In a multiprocessor system with shared memory, cache coherency is maintained by sending snoop cycles to all cache agents and collecting their snoop responses to determine the final state of a cache line. If the cache line has been updated, appropriate actions are taken to ensure global visibility of the latest update. The current generation of CPUs performs cache coherency on a per cache line basis and must spawn snoop cycles to internal as well as external cache agents for each cache line access. As such, snooping traffic often times occupy a sizeable portion of CPU processing time and cache bandwidth. This issue is especially evident when snoop activities are delayed due to latencies in communicating with external interconnects or conflicts with ongoing internal accesses, resulting in significant degradation in system performance. Thus, there exists a need to reduce cache bandwidth used by snooping traffic for ensuring cache coherency.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a block diagram illustrating an exemplary hardware system implementing the task list in accordance with an embodiment of the present invention.

FIG. 2 illustrates an embodiment of the task list.

FIG. 3 is a flow diagram illustrating a method for fetching data blocks by a cache agent according to one embodiment.

FIG. 4A is a block diagram illustrating both an exemplary in-order pipeline and an exemplary register renaming, out-of-order issue/execution pipeline according to embodiments of the invention;

FIG. 4B is a block diagram illustrating both an exemplary embodiment of an in-order architecture core and an exemplary register renaming, out-of-order issue/execution architecture core to be included in a processor according to embodiments of the invention;

FIG. 5 is a block diagram of a single core processor and a multicore processor with integrated memory controller and graphics according to embodiments of the invention;

FIG. 6 illustrates a block diagram of a system in accordance with one embodiment of the present invention;

FIG. 7 illustrates a block diagram of a second system in accordance with an embodiment of the present invention;

FIG. 8 illustrates a block diagram of a third system in accordance with an embodiment of the present invention;

FIG. 9 illustrates a block diagram of a system on a chip (SoC) in accordance with an embodiment of the present invention;

FIG. 10 illustrates a block diagram contrasting the use of a software instruction converter to convert binary instructions in a source instruction set to binary instructions in a target instruction set according to embodiments of the invention;

### DETAILED DESCRIPTION

Embodiments implementing a task list in a cache agent for reducing cache line snoops is described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. For clarity, individual components in the Figures herein may be referred to by their labels in the Figures, rather than by a particular reference number.

Embodiments detailed herein relate to “task-based coherency” to reduce the necessity of cache snoops in a shared memory system. A task is a data block object that may be attached with an associated operation or command. Each data block object comprises one or more data units that can be associated with a coherency state. In one embodiment, a data unit is simply a cache line or a data block. Every cache agent in the shared memory system maintains a task list to track the tasks it has acquired. According to an embodiment, a cache agent refers to any participant of the cache snoop cycle for maintaining cache coherency in the shared memory system, such as an field programmable gateway array (FPGA) or a hardware processor or core. The task list is a finite size table that resides in coherent memory space and contains a list of task entries wherein each task entry specifies a data block that the cache agent is to operate on. A cache agent, upon detecting a task entry inserted into its task list, snoops its task list to determine how it should process or respond to the request. Through the use of a task list, cache coherency is maintained on the data blocks associated with tasks rather than on a per cache line basis.

According to an embodiment, each cache agent (e.g., an FPGA) in the system comprises a task manager that prioritizes, checks, and maintains cache coherency with other cache agents, as well as assigns tasks to processing units within the cache agent. The cache coherency described here is the coherency of the tasks within the task list. Every task within the task list is fully cache coherent on a cache line basis. This means that every cache line within a data block is considered to be the same state as the task. Since coherency is maintained on each task, rather than each cache line, individual cache lines do not participate in cache line snooping. Moreover, since each cache agent's task list is fully coherent and globally visible to all other cache agents, the task lists are monitored and modified by the cache agents for sending and receiving requests for data processing.

Consider a memory system with coherent space and non-coherent space where accesses to the coherent space generates snoops across the system while accesses to the non-coherent space do not generate snoops. In this exemplary memory system, the task list resides in the coherent space while data blocks reside in the non-coherent space. Each task entry in the task list provides the required cache coherency state as well as information of the data block, such as its location and size. Each task list of a cache agent is managed by the cache agent's task manager hardware. When a new request is detected in the form of an update to the task list entry, the task manager checks the cache state of the data block as indicated by the task entry and determines whether the required data block is available in local cache memory or needs to be fetched from the non-coherent system memory. Based on that determination, data is fetched and fed into a processing unit for processing. The results are then stored in either the local cache memory or directly to the non-coherent space of the system memory. Additionally, if the results require further processing by other cache agents or processing units, the task manager also has the option to write the data to the coherent memory space of system memory to be immediately visible by other cache agents.

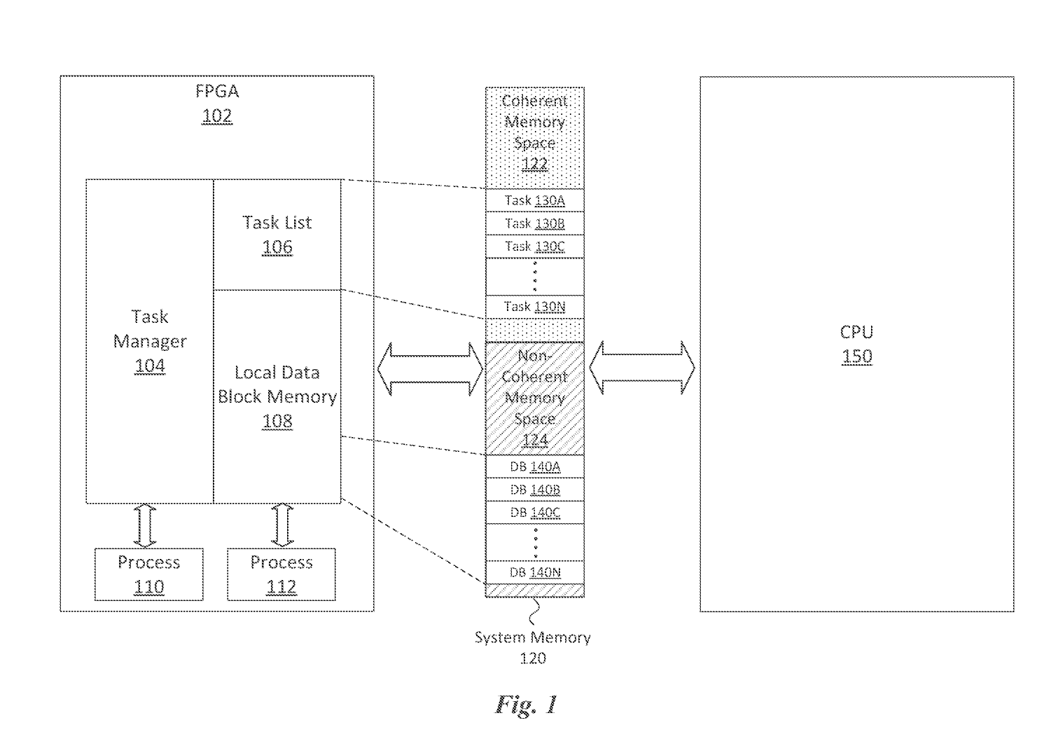

FIG. 1 illustrates an exemplary system utilizing the task list according to an embodiment. The system comprises a hardware processor or core (CPU, GPU, APU, ASIC, or cores thereof) shown as CPU 150 and a Field Programmable Gate Array (FPGA) 102 sharing a system memory 120. The FPGA 102 further comprises one or more processing units (e.g., 110 and 112) and a task manager 104 for managing task list 106 and local data block memory 108. In one embodiment, the local data block memory 108 is the FPGA cache. The system memory 120 is divided into coherent memory space 122 and non-coherent memory space 124. The task list 106, which comprises N tasks 130A-130N resides in the coherent memory space 122. The data blocks 140A-140N resides in the non-coherent memory space 124.

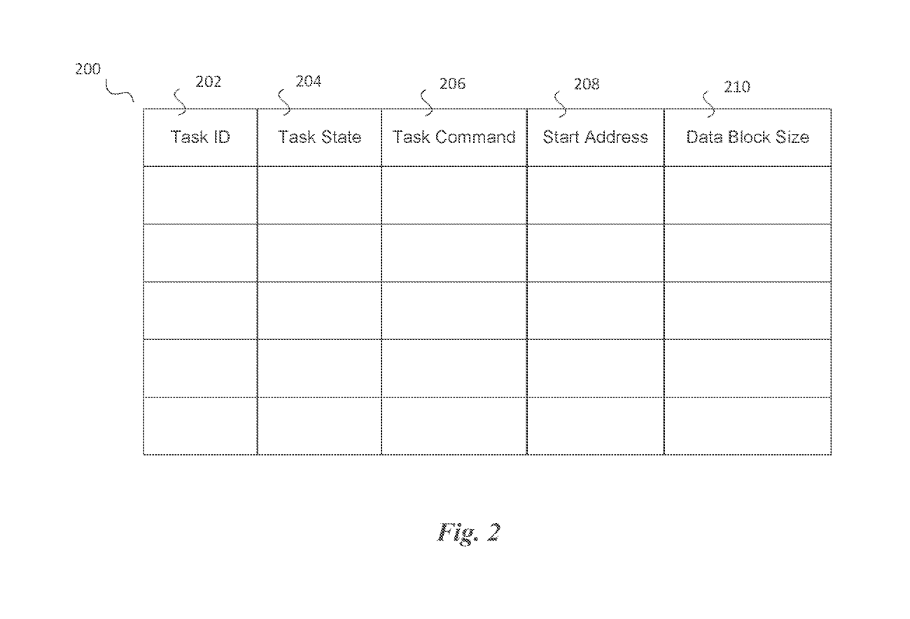

FIG. 2 illustrates an embodiment of a task list. Each entry in the task list 200 stores one task and is comprised of various fields. In one embodiment, the task entry fields include one or more of task ID field 202, task state field 204, task command field 206, start address field 208, and data block size field 210. Task ID field 202 contains a unique ID assigned to each task. According to an embodiment, the task ID field 202 of a task is simply the task's cache line offset from the task list's base address. Task state field 204 stores the current status of a task which may be one of several states, such as empty, idle, modified, exclusive, shared, invalid, and pending. In one embodiment, the pending state further comprises pending modified, pending exclusive, pending shared, and pending invalid. Other states, while not listed here, may also be used. The empty state indicates that the task entry does not contains a valid task and is available for storing a new task. The idle state indicates that the task entry is currently inactive. Modified, exclusive, shared, and invalid (MESI) states indicate the current coherency state of the data block associated with task, similar to what is used for maintaining cache line coherency. The modified state indicates that the task entry is available only within the current task list and not in the system memory. Exclusive state means the task entry is available both within the current task list and in the system memory. Shared state indicates that the task entry is available within the current task list but also in the task list of one or more other cache agents, as well as in system memory. Invalid state means the task entry is invalid. The pending state indicates that the task is in the process of transitioning to a state. The task command field 206, stores the command or request to be performed by the cache agent. According to an embodiment, command field 206 comprises one of read, write, or process requests. A read request causes the cache agent to read a data block from local memory or system memory, a write request causes the cache agent to write a data block to local or system memory, and a process request instructs the cache agent to process a specified data block currently residing in either local memory or system memory. The address of the data block to be acted upon by the cache agent is stored in the data start address field 208 of the task entry. The data block size field 210 specifies the size of the data block that begins from the start address indicated by the start address field 208.

As noted above, each cache agent maintains a task list that is managed by each cache agent's local task manager. A request is made to the OS to request allocation in the coherent memory space, such as a memory page, to be used for a task list. In one embodiment, the request is made by software, such as one running on the cache agent. In another embodiment, the task manager makes the request for coherent memory space at the direction of the software. After allocation of the memory space, the software or the task manager initializes the task list by setting the task list's address register to the address of the requested memory page, as well as setting every task entry's task state to the empty state. The empty state indicates that the task entry is available for storing a new task. Next, the task manager loads the list of tasks from the coherent space of system memory (i.e., tasks 130A-130N of FIG. 1) in to the task list 106 of the cache agent. Accordingly, the task manager and/or software also sets up data blocks 140A-140N in the non-coherent memory space of system memory. The software then can request the cache agents to perform tasks, such as to process a given data block, by simply inputting a valid task into an empty task entry. In one embodiment, each task entry comprises one cache line.

Now, to request a particular cache agent to perform a task, a requestor, such as another cache agent, updates the task list of the particular cache agent in the coherent memory space. When the task list of the particular task agent is updated, the hardware processor generates a snoop invalidate request to all the cache agents in the system to invalidate stale copies of the updated task entry in order to maintain task list coherency. Upon receiving snoop invalidate request, the particular task manager responsively requests the updated copy of the task entry from the task list in system memory. Next, based upon the information contained in the updated task entry, such as the task state, the task manger determines whether the data on which to carry out the task is available locally or must be fetched from non-coherent memory space of the system memory. Once the task entry and the data block are retrieved and stored into the cache agent's local memory cache, the task manager checks the availability of local resources and assigns the task to the appropriate processing units for processing. With the assignment of the task, the task manager also sets the task entry's task state to pending. When the task command is completed, the task manager updates the task with the appropriate information, such as setting the task state to one of the MESI states or updating the start address or size of the data block to reflect where the results are stored. Moreover, a request, such as an InvItoE cycle, is sent to the hardware processor to indicate the completion of the task. The hardware processor, in turn, uses the request to detect updates to the task list made by the task manager. In many cases, processing of a data block from one task may spawn a new task (e.g. generates a new output data block). In such case, the updated task entry may also contain the task ID for a new task.

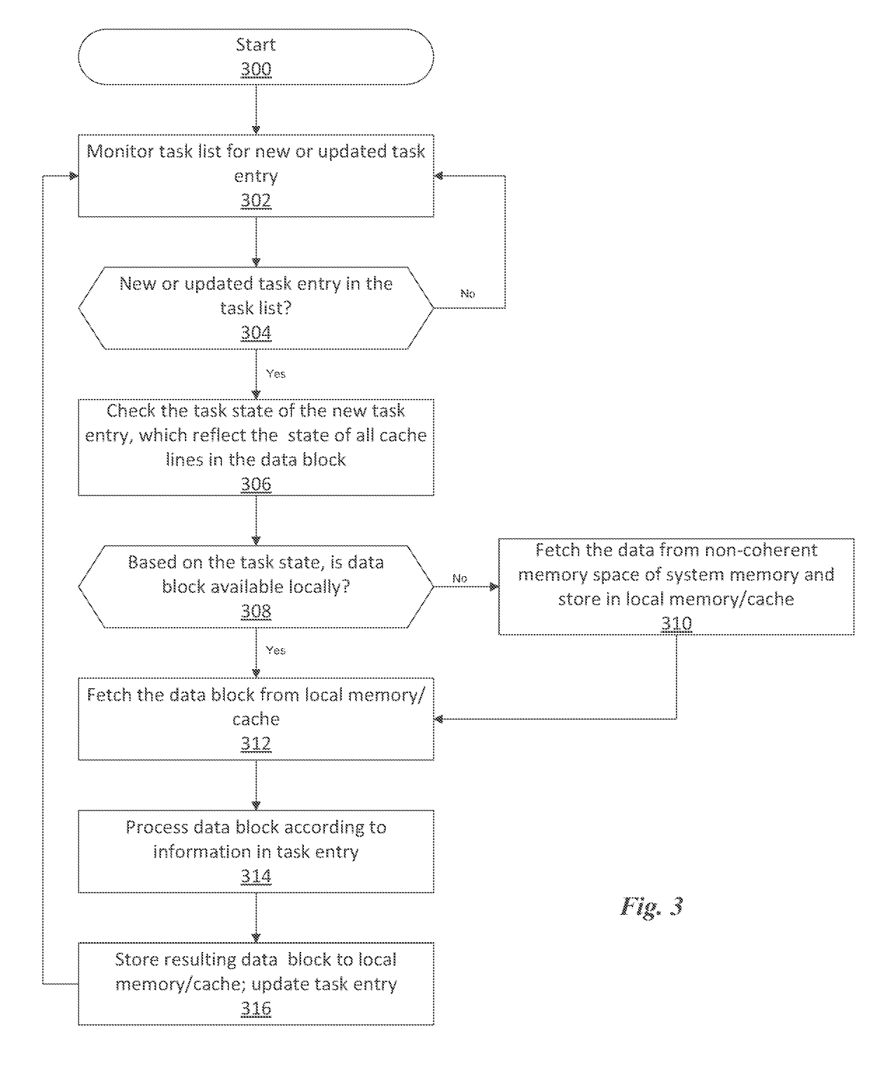

FIG. 3 is a flow diagram illustrating a method for fetching data blocks performed by a cache agent according to an embodiment. At block 302, the task manager of the cache agent monitors the task list for new or updated task entry. At block 304, a determination is made on whether any of the task entry in the task list was added or updated. If the task list was not updated, the task manager continues to monitor the task list back at block 302. On the other hand, if the task list was updated, at block 306, the task manager checks the task state of the updated task entry. The task state reflects the coherency state of the task entry as well as that of the data block associated with the task entry. At block 308, based on the task state, the task manager determines whether the data block is available locally to the cache agent or whether the data block must first be fetched from system memory. For instance, an “invalid” task state would indicate that the cache agent does not have the data block locally and the task manager must fetch the data block from the non-coherent memory space in system memory and store into the cache agent's local memory or cache, as shown in block 310. On the other hand, a “modified” task state would indicate that the cache agent's local memory or cache contains the only copy of the data block and thus there is no need to fetch from system memory. If and when the cache agent has the data block in local memory or cache, at block 312, the task manager fetches the data block from local memory or cache and feeds it to the processing unit. At block 314, the data block is processed by the processing units in accordance to the information contained in the task entry, such as carrying out the task command. At block 316, the result from processing the task command on the data block is store into the cache agent's local memory or cache. Moreover, the task entry that was processed is also updated accordingly. Thereafter, the task manager returns to monitoring the task list back at block 302.

To further detail how the task list operates, the following example illustrates the task list used in a hardware processor system that utilizes one or more FPGAs to provide acceleration for data block processing according to an embodiment. Specifically, data block processing may include compression, imaging, pattern matching, matrix multiplication, etc.

First, a software running in the system and executed by the hardware processor acquires a cacheable memory page (2 MB) from the OS to be used as the FPGA task list. The software initializes the memory page and issues a request, such as a NcCfgWr (Configuration Write cycle), to set the FPGA task list base address in the control and status register (CSR) to the allocated memory page. When the software sets the FPGA task list base address, the FPGA detects the operation and responsively updates its task list, such as sending a read code to system memory to load the task list contents from coherent memory space. The FPGA is able to detect the software's action of setting the FPGA task list base address because the FPGA task list is stored in the coherent memory space of the system memory and therefore is visible and monitored by all cache agents in the system. This includes the FPGA. The task list contains task entries where each entry has a unique task ID. Both the software and FPGA task managers use the task entry offset from task as the entry's task ID. Task ID acts as the identifier and index to the task list. Next, the software sets up the data blocks in the non-coherent memory. To assign task to the FPGA, the software writes to the FPGA's task list in the system memory. The task entry entered by the software contains all the information required for the task. For example, assume the software enters the following command into entry #12 of task list:

FPGA compute 1/X on task #12 and writes output to task #34

As noted above, the task list is in the coherent memory space. As such, when the software updates a task entry in the task list, all other copies of the task entry are now stale. Accordingly, in one embodiment, the hardware processor generates a snoop invalidate request to invalidate any old copies of the modified task entry that may be present in other cache agents, including the FPGA. The address of the task entry to be invalidated is the task list's base address plus an offset which is the task ID. Upon receiving the snoop invalidate request from the hardware processor, the FPGA's task manager responds by sending a read code request to the hardware processor to acquire the latest version of task entry #12. Next, the FPGA task manager takes the new data from the updated task entry #12 and processes it.

FPGA task manager checks its processing unit and resources, then allocates available resources to the task. It also sets the task #12 to pending Share state which prevents other dependent tasks from occurring. In order to process task #12, the data block indicated by task #12 must first be obtained. Thus, the task manager of the FPGA makes a request for the corresponding data block from the non-coherent memory space in system memory and store the requested data block to the FPGA's local memory. Since the data block is in the non-coherent memory space, fetching the data produces no snoops. Next, the requested data block is fed to FPGA's processing units by the task manager for processing. The outputted results are then written to the designated data block in the FPGA's local memory. Task entry #34 in the FPGA's task list is also updated to reflect the result from processing task entry #12. Thus, when FPGA finishes processing task entry #12, the FPGA's local memory contains both task entry #12 and an updated task entry #34. Task entry #12 is in Shared state (input data block read) while task entry #34 is in Modified state (output data block produced). Next, the task manager sends Invalidate I to E request to the hardware processor.

Suppose the software decided to request more processing. The hardware processor checks the current states of the task list and update the task entries with a new request:

FPGA multiply task #34 with task #56 and write output to task #12

FPGA task manager receives the new commands in the same manner as described above. It checks its processing unit and resources, then allocate available resources to the task #34 and task #56

For task entry #34, which stores the results from the previous operation described above and stored in the FPGA's task list and local memory, all the data is available locally to the FPGA. As such, the FPGA's task manager fetches the data specified by task entry #34 from the FPGA local memory as oppose to the system memory. On the other hand, since task #56 is new and not yet in the FPGA's task list or local memory, it must first be acquired. As such, the FPGA's task manager fetches the data block for task #56 from the system memory's non-coherent memory space.

After task entry #56 is added to the task list and the corresponding data is loaded in the local memory, FPGA processing units perform multiplication of the two data blocks, and write its results to the data block associated with task entry #12. Since task entry #12 is in shared state, the data block associated with the entry is not the only copy and therefore can safely be dropped or overwritten. As such, the data block in the FPGA associated with task entry #12 is replaced by the result from the multiplication. Accordingly, the FPGA updates its task list to reflect the latest information as follows:

Task #12 in Modified state (the address of task #12 may be different from the old task #12)
Task #34 in Modified state (task manger may set task state to I state if the data can discarded)
Task #56 in Shared state (input data block read)

The above example illustrates how the task based snooping works. The main benefit is the elimination of snoops for the data blocks; instead of generating snoops on every cache line, the data block can be move coherently between different agents using the task lists. The elimination of the snoops will increase system performance in BW, lower latency, as well as reduce power.

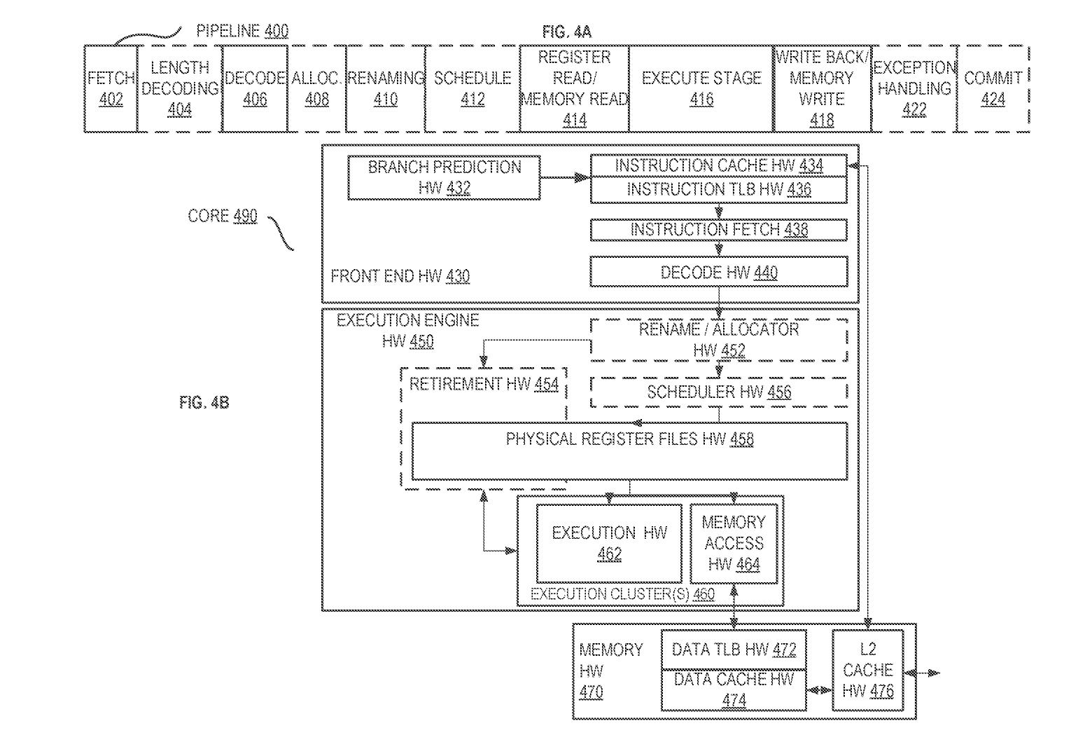

FIG. 4A is a block diagram illustrating both an exemplary in-order pipeline and an exemplary register renaming, out-of-order issue/execution pipeline according to embodiments of the invention. FIG. 4B is a block diagram illustrating both an exemplary embodiment of an in-order architecture core and an exemplary register renaming, out-of-order issue/execution architecture core to be included in a processor according to embodiments of the invention. The solid lined boxes in FIGS. 4A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 4A, a processor pipeline 400 includes a fetch stage 402, a length decode stage 404, a decode stage 406, an allocation stage 408, a renaming stage 410, a scheduling (also known as a dispatch or issue) stage 412, a register read/memory read stage 414, an execute stage 416, a write back/memory write stage 418, an exception handling stage 422, and a commit stage 424.

FIG. 4B shows processor core 490 including a front end hardware 430 coupled to an execution engine hardware 450, and both are coupled to a memory hardware 470. The core 490 may be a reduced instruction set computing (RISC) core, a complex instruction set computing (CISC) core, a very long instruction word (VLIW) core, or a hybrid or alternative core type. As yet another option, the core 490 may be a special-purpose core, such as, for example, a network or communication core, compression engine, coprocessor core, general purpose computing graphics processing unit (GPGPU) core, graphics core, or the like.

The front end hardware 430 includes a branch prediction hardware 432 coupled to an instruction cache hardware 434, which is coupled to an instruction translation lookaside buffer (TLB) 436, which is coupled to an instruction fetch hardware 438, which is coupled to a decode hardware 440. The decode hardware 440 (or decoder) may decode instructions, and generate as an output one or more micro-operations, micro-code entry points, microinstructions, other instructions, or other control signals, which are decoded from, or which otherwise reflect, or are derived from, the original instructions. The decode hardware 440 may be implemented using various different mechanisms. Examples of suitable mechanisms include, but are not limited to, look-up tables, hardware implementations, programmable logic arrays (PLAs), microcode read only memories (ROMs), etc. In one embodiment, the core 490 includes a microcode ROM or other medium that stores microcode for certain macroinstructions (e.g., in decode hardware 440 or otherwise within the front end hardware 430). The decode hardware 440 is coupled to a rename/allocator hardware 452 in the execution engine hardware 450.

The execution engine hardware 450 includes the rename/allocator hardware 452 coupled to a retirement hardware 454 and a set of one or more scheduler hardware 456. The scheduler hardware 456 represents any number of different schedulers, including reservations stations, central instruction window, etc. The scheduler hardware 456 is coupled to the physical register file(s) hardware 458. Each of the physical register file(s) hardware 458 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) hardware 458 comprises a vector registers hardware, a write mask registers hardware, and a scalar registers hardware. These register hardware may provide architectural vector registers, vector mask registers, and general purpose registers. The physical register file(s) hardware 458 is overlapped by the retirement hardware 454 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement hardware 454 and the physical register file(s) hardware 458 are coupled to the execution cluster(s) 460. The execution cluster(s) 460 includes a set of one or more execution hardware 462 and a set of one or more memory access hardware 464. The execution hardware 462 may perform various operations (e.g., shifts, addition, subtraction, multiplication) and on various types of data (e.g., scalar floating point, packed integer, packed floating point, vector integer, vector floating point). While some embodiments may include a number of execution hardware dedicated to specific functions or sets of functions, other embodiments may include only one execution hardware or multiple execution hardware that all perform all functions. The scheduler hardware 456, physical register file(s) hardware 458, and execution cluster(s) 460 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler hardware, physical register file(s) hardware, and/or execution cluster—and in the case of a separate memory access pipeline, certain embodiments are implemented in which only the execution cluster of this pipeline has the memory access hardware 464). It should also be understood that where separate pipelines are used, one or more of these pipelines may be out-of-order issue/execution and the rest in-order.

The set of memory access hardware 464 is coupled to the memory hardware 470, which includes a data TLB hardware 472 coupled to a data cache hardware 474 coupled to a level 2 (L2) cache hardware 476. In one exemplary embodiment, the memory access hardware 464 may include a load hardware, a store address hardware, and a store data hardware, each of which is coupled to the data TLB hardware 472 in the memory hardware 470. The instruction cache hardware 434 is further coupled to a level 2 (L2) cache hardware 476 in the memory hardware 470. The L2 cache hardware 476 is coupled to one or more other levels of cache and eventually to a main memory.

By way of example, the exemplary register renaming, out-of-order issue/execution core architecture may implement the pipeline 400 as follows: 1) the instruction fetch 438 performs the fetch and length decoding stages 402 and 404; 2) the decode hardware 440 performs the decode stage 406; 3) the rename/allocator hardware 452 performs the allocation stage 408 and renaming stage 410; 4) the scheduler hardware 456 performs the schedule stage 412; 5) the physical register file(s) hardware 458 and the memory hardware 470 perform the register read/memory read stage 414; the execution cluster 460 perform the execute stage 416; 6) the memory hardware 470 and the physical register file(s) hardware 458 perform the write back/memory write stage 418; 7) various hardware may be involved in the exception handling stage 422; and 8) the retirement hardware 454 and the physical register file(s) hardware 458 perform the commit stage 424.

The core 490 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 490 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache hardware 434/474 and a shared L2 cache hardware 476, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

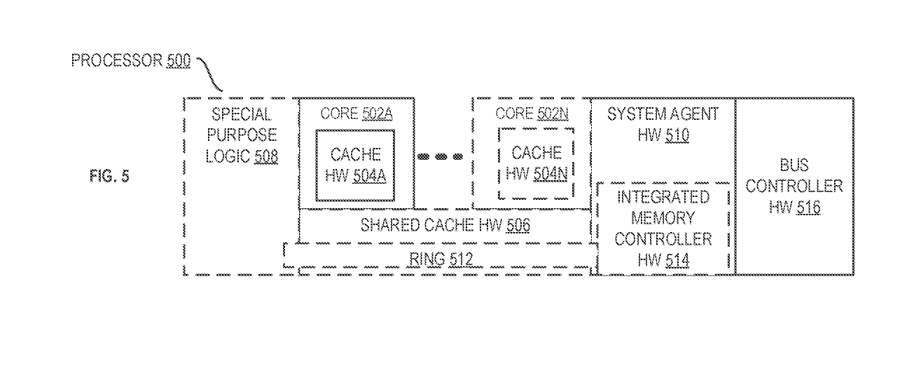

FIG. 5 is a block diagram of a processor 500 that may have more than one core, may have an integrated memory controller, and may have integrated graphics according to embodiments of the invention. The solid lined boxes in FIG. 5 illustrate a processor 500 with a single core 502A, a system agent 510, a set of one or more bus controller hardware 516, while the optional addition of the dashed lined boxes illustrates an alternative processor 500 with multiple cores 502A-N, a set of one or more integrated memory controller hardware 514 in the system agent hardware 510, and special purpose logic 508.

Thus, different implementations of the processor 500 may include: 1) a CPU with the special purpose logic 508 being integrated graphics and/or scientific (throughput) logic (which may include one or more cores), and the cores 502A-N being one or more general purpose cores (e.g., general purpose in-order cores, general purpose out-of-order cores, a combination of the two); 2) a coprocessor with the cores 502A-N being a large number of special purpose cores intended primarily for graphics and/or scientific (throughput); and 3) a coprocessor with the cores 502A-N being a large number of general purpose in-order cores. Thus, the processor 500 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 500 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache hardware 506, and external memory (not shown) coupled to the set of integrated memory controller hardware 514. The set of shared cache hardware 506 may include one or more mid-level caches, such as level 2 (L2), level 3 (L3), level 4 (L4), or other levels of cache, a last level cache (LLC), and/or combinations thereof. While in one embodiment a ring based interconnect hardware 512 interconnects the integrated graphics logic 508, the set of shared cache hardware 506, and the system agent hardware 510/integrated memory controller hardware 514, alternative embodiments may use any number of well-known techniques for interconnecting such hardware. In one embodiment, coherency is maintained between one or more cache hardware 506 and cores 502-A-N.

In some embodiments, one or more of the cores 502A-N are capable of multi-threading. The system agent 510 includes those components coordinating and operating cores 502A-N. The system agent hardware 510 may include for example a power control unit (PCU) and a display hardware. The PCU may be or include logic and components needed for regulating the power state of the cores 502A-N and the integrated graphics logic 508. The display hardware is for driving one or more externally connected displays.

The cores 502A-N may be homogenous or heterogeneous in terms of architecture instruction set; that is, two or more of the cores 502A-N may be capable of execution the same instruction set, while others may be capable of executing only a subset of that instruction set or a different instruction set. In one embodiment, the cores 502A-N are heterogeneous and include both the “small” cores and “big” cores described below.

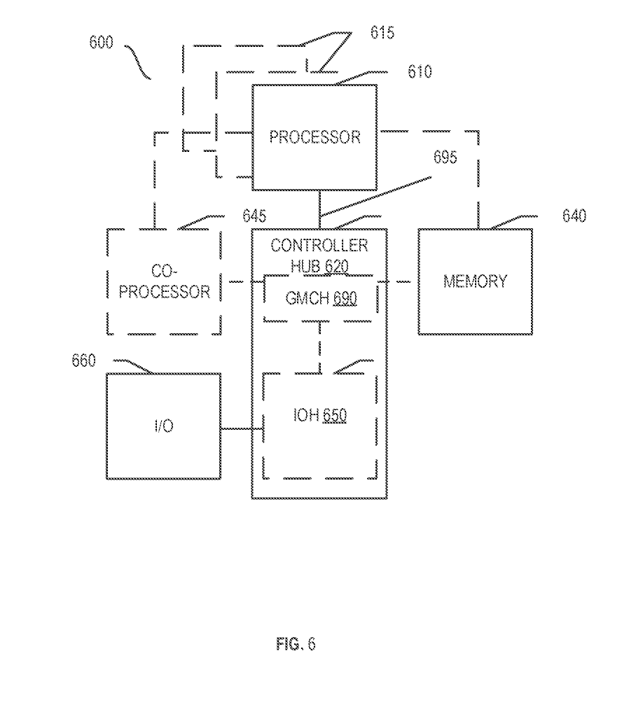

FIGS. 6-9 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 6, shown is a block diagram of a system 600 in accordance with one embodiment of the present invention. The system 600 may include one or more processors 610, 615, which are coupled to a controller hub 620. In one embodiment the controller hub 620 includes a graphics memory controller hub (GMCH) 690 and an Input/Output Hub (IOH) 650 (which may be on separate chips); the GMCH 690 includes memory and graphics controllers to which are coupled memory 640 and a coprocessor 645; the IOH 650 is couples input/output (I/O) devices 660 to the GMCH 690. Alternatively, one or both of the memory and graphics controllers are integrated within the processor (as described herein), the memory 640 and the coprocessor 645 are coupled directly to the processor 610, and the controller hub 620 in a single chip with the IOH 650.

The optional nature of additional processors 615 is denoted in FIG. 6 with broken lines. Each processor 610, 615 may include one or more of the processing cores described herein and may be some version of the processor 500.

The memory 640 may be, for example, dynamic random access memory (DRAM), phase change memory (PCM), or a combination of the two. For at least one embodiment, the controller hub 620 communicates with the processor(s) 610, 615 via a multi-drop bus, such as a frontside bus (FSB), point-to-point interface, or similar connection 695.

In one embodiment, the coprocessor 645 is a special-purpose processor, such as, for example, a high-throughput MIC processor, a network or communication processor, compression engine, graphics processor, GPGPU, embedded processor, or the like. In one embodiment, controller hub 620 may include an integrated graphics accelerator.

There can be a variety of differences between the physical resources 610, 615 in terms of a spectrum of metrics of merit including architectural, microarchitectural, thermal, power consumption characteristics, and the like.

In one embodiment, the processor 610 executes instructions that control data processing operations of a general type. Embedded within the instructions may be coprocessor instructions. The processor 610 recognizes these coprocessor instructions as being of a type that should be executed by the attached coprocessor 645. Accordingly, the processor 610 issues these coprocessor instructions (or control signals representing coprocessor instructions) on a coprocessor bus or other interconnect, to coprocessor 645. Coprocessor(s) 645 accept and execute the received coprocessor instructions.

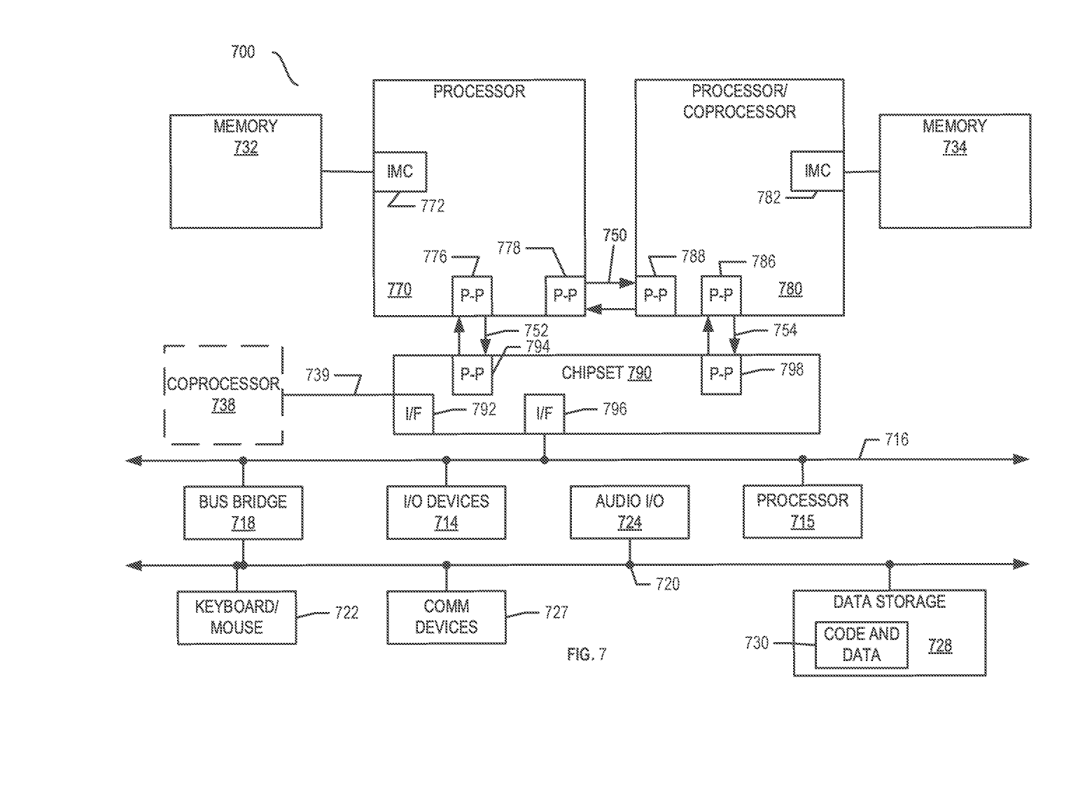

Referring now to FIG. 7, shown is a block diagram of a first more specific exemplary system 700 in accordance with an embodiment of the present invention. As shown in FIG. 7, multiprocessor system 700 is a point-to-point interconnect system, and includes a first processor 770 and a second processor 780 coupled via a point-to-point interconnect 750. Each of processors 770 and 780 may be some version of the processor 500. In one embodiment of the invention, processors 770 and 780 are respectively processors 610 and 615, while coprocessor 738 is coprocessor 645. In another embodiment, processors 770 and 780 are respectively processor 610 coprocessor 645.

Processors 770 and 780 are shown including integrated memory controller (IMC) hardware 772 and 782, respectively. Processor 770 also includes as part of its bus controller hardware point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 may each exchange information with a chipset 790 via individual P-P interfaces 752, 754 using point to point interface circuits 776, 794, 786, 798. Chipset 790 may optionally exchange information with the coprocessor 738 via a high-performance interface 739. In one embodiment, the coprocessor 738 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present invention is not so limited.

As shown in FIG. 7, various I/O devices 714 may be coupled to first bus 716, along with a bus bridge 718 which couples first bus 716 to a second bus 720. In one embodiment, one or more additional processor(s) 715, such as coprocessors, high-throughput MIC processors, GPGPU's, accelerators (such as, e.g., graphics accelerators or digital signal processing (DSP) hardware), field programmable gate arrays, or any other processor, are coupled to first bus 716. In one embodiment, second bus 720 may be a low pin count (LPC) bus. Various devices may be coupled to a second bus 720 including, for example, a keyboard and/or mouse 722, communication devices 727 and a storage hardware 728 such as a disk drive or other mass storage device which may include instructions/code and data 730, in one embodiment. Further, an audio I/O 724 may be coupled to the second bus 720. Note that other architectures are possible. For example, instead of the point-to-point architecture of FIG. 7, a system may implement a multi-drop bus or other such architecture.

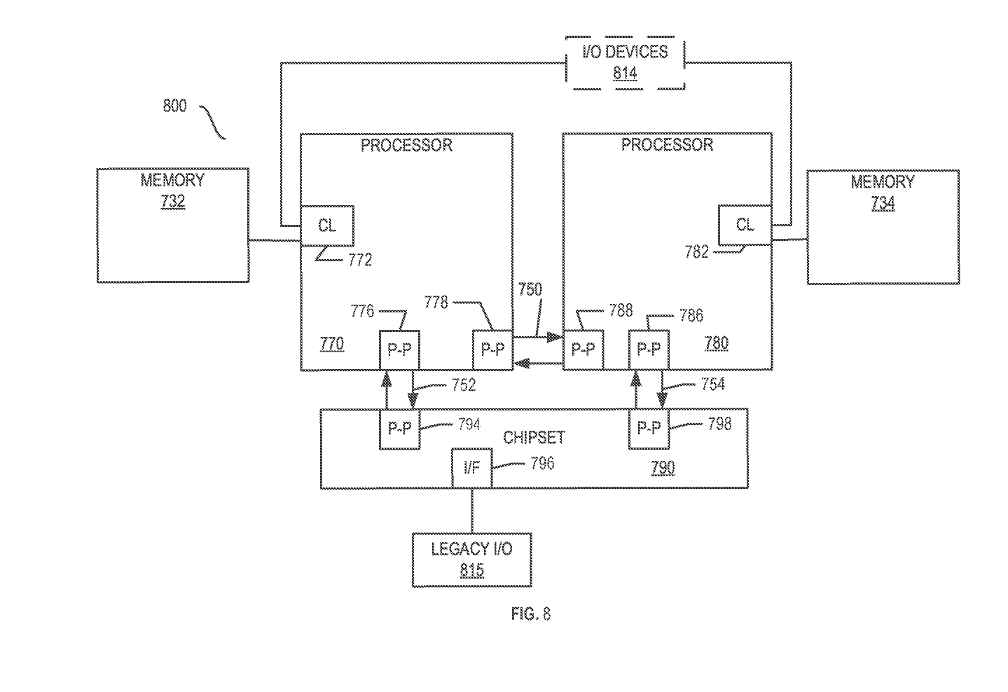

Referring now to FIG. 8, shown is a block diagram of a second more specific exemplary system 800 in accordance with an embodiment of the present invention Like elements in FIGS. 7 and 8 bear like reference numerals, and certain aspects of FIG. 7 have been omitted from FIG. 8 in order to avoid obscuring other aspects of FIG. 8.

FIG. 8 illustrates that the processors 770, 780 may include integrated memory and I/O control logic (“CL”) 772 and 782, respectively. Thus, the CL 772, 782 include integrated memory controller hardware and include I/O control logic. FIG. 8 illustrates that not only are the memories 732, 734 coupled to the CL 772, 782, but also that I/O devices 814 are also coupled to the control logic 772, 782. Legacy I/O devices 815 are coupled to the chipset 790.

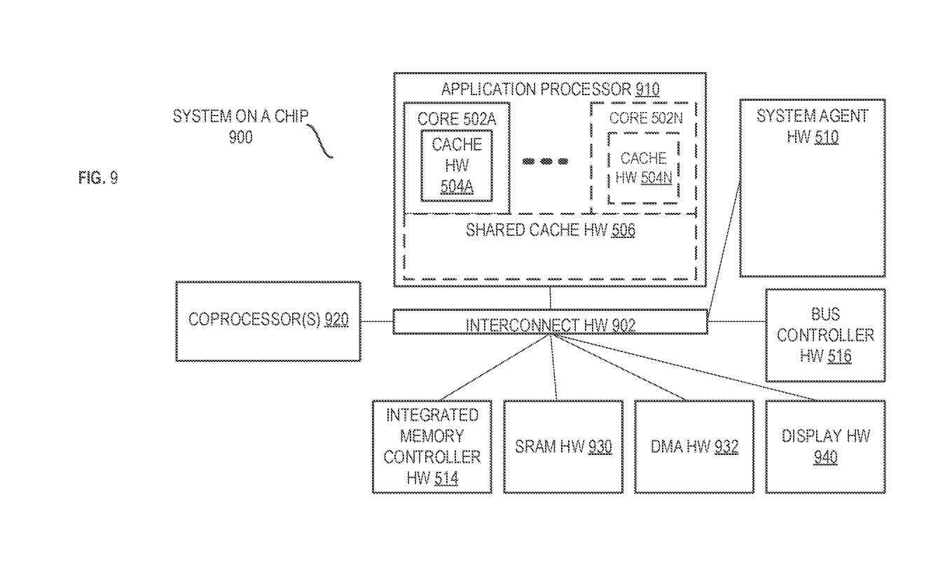

Referring now to FIG. 9, shown is a block diagram of a SoC 900 in accordance with an embodiment of the present invention. Similar elements in FIG. 5 bear like reference numerals. Also, dashed lined boxes are optional features on more advanced SoCs. In FIG. 9, an interconnect hardware 902 is coupled to: an application processor 910 which includes a set of one or more cores 502A-N and shared cache hardware 506; a system agent hardware 510; a bus controller hardware 516; an integrated memory controller hardware 514; a set or one or more coprocessors 920 which may include integrated graphics logic, an image processor, an audio processor, and a video processor; an static random access memory (SRAM) hardware 930; a direct memory access (DMA) hardware 932; and a display hardware 940 for coupling to one or more external displays. In one embodiment, the coprocessor(s) 920 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 730 illustrated in FIG. 7, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

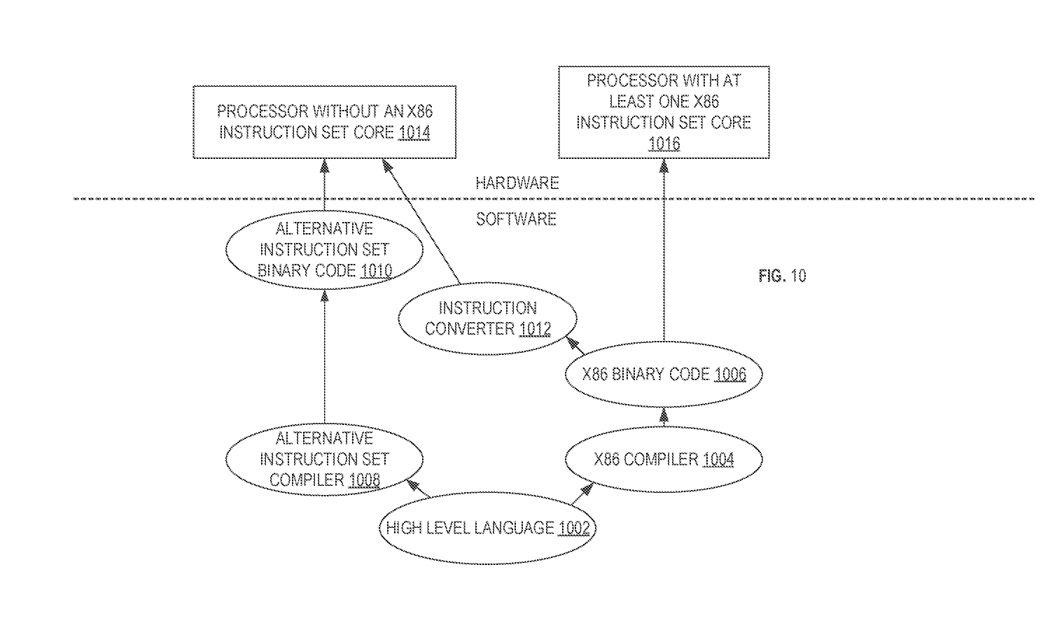

FIG. 10 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 10 shows a program in a high level language 1002 may be compiled using an x86 compiler 1004 to generate x86 binary code 1006 that may be natively executed by a processor with at least one x86 instruction set core 1016. The processor with at least one x86 instruction set core 1016 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1004 represents a compiler that is operable to generate x86 binary code 1006 (e.g., object code) that can, with or without additional linkage processing, be executed on the processor with at least one x86 instruction set core 1016. Similarly, FIG. 10 shows the program in the high level language 1002 may be compiled using an alternative instruction set compiler 1008 to generate alternative instruction set binary code 1010 that may be natively executed by a processor without at least one x86 instruction set core 1014 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1012 is used to convert the x86 binary code 1006 into code that may be natively executed by the processor without an x86 instruction set core 1014. This converted code is not likely to be the same as the alternative instruction set binary code 1010 because an instruction converter capable of this is difficult to make; however, the converted code will accomplish the general operation and be made up of instructions from the alternative instruction set. Thus, the instruction converter 1012 represents software, firmware, hardware, or a combination thereof that, through emulation, simulation or any other process, allows a processor or other electronic device that does not have an x86 instruction set processor or core to execute the x86 binary code 1006.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method implemented in a shared cache memory system, the method comprising:
monitoring a list of tasks that is stored in a shared cache memory and shared by a plurality of cache agents, wherein each task in the list of tasks is associated with at least a data block, a task command, and a task state, and wherein the list of tasks is fully coherent amongst the plurality of cache agents and the data block associated with each task is not coherent amongst the plurality of cache agents;
detecting an access to the list of tasks and responsive to the detecting, snoop the list of tasks to generate a response, wherein the response comprises performing the task command of the accessed task on the associated data block to generate a result and storing the result in the same or different data block.

2. The method of claim 1, wherein the list of tasks is fully coherent such that accesses to the list of tasks generate snoop requests to the plurality of cache agents in the shared cache memory system.

3. The method of claim 1, wherein the data block is not coherent such that accesses to the data block do not generate snoop requests to the plurality of cache agents in the shared cache memory system.

4. The method of claim 1, wherein the data block comprises one or more cache lines.

5. The method of claim 4, wherein the one or more cache lines within the data block all have the same task state as the task entry.

6. The method of claim 1, wherein each task is further associated with a task ID.

7. The method of claim 6, wherein the task ID of a given task is an offset between the given task's address and the task list's base address.

8. The method of claim 1, wherein the shared cache memory and one or more of the plurality of cache agents each maintains a copy of the task list.

9. The method of claim 1, wherein performing the task command comprises one of reading the associated data block, writing to the associated data block, or process the associated data block.

10. The method of claim 1, wherein the task state comprises one of empty state, idle state, modified state, exclusive state, shared state, invalid state, or pending state.

11. A shared cache memory system comprising:
a shared cache memory;
a plurality of cache agents coupled to the shared cache memory, wherein each of the plurality cache agents to:
monitor a list of tasks that is stored in the shared cache memory and shared by the plurality of cache agents, wherein each task in the list of tasks is associated with at least a data block, a task command, and a task state, and wherein the list of tasks is fully coherent amongst the plurality of cache agents and the data block associated with each task is not coherent amongst the plurality of cache agents;
detect an access to the list of tasks and responsive to the detection, snoop the list of tasks to generate a response, wherein the response comprises performing the task command of the accessed task on the associated data block to generate a result and storing the result in the same or different data block.

12. The system of claim 11, wherein the list of tasks is fully coherent such that accesses to the list of tasks generate snoop requests to the plurality of cache agents in the shared cache memory system.

13. The system of claim 11, wherein the data block is not coherent such that accesses to the data block do not generate snoop requests to the plurality of cache agent in the shared cache memory system.

14. The system of claim 11, wherein the data block comprises one or more cache lines.

15. The system of claim 14, wherein the one or more cache lines within the data block have the same task state as the task entry.

16. The system of claim 11, wherein each task is further associated with a task ID.

17. The system of claim 16, wherein the task ID of a given task is an offset between the given task's address and the task list's base address.

18. The system of claim 11, wherein the shared cache memory and one or more of the plurality of cache agents each maintains a copy of the task list.

19. The system of claim 11, wherein performing the task command comprises one of reading the associated data block, writing to the associated data block, or process the associated data block.

20. The system of claim 11, wherein the task state comprises one of empty state, idle state, modified state, exclusive state, shared state, invalid state, and pending state.

21. The system of claim 11, wherein each of the plurality of cache agent further comprises a task manager to prioritize, check, and maintain cache coherency of the task list with other cache agents, as well as to assign task to one or more processing units within the cache agent.
